(19) United States
(12) Patent Application Publication
(10) Pub. No.: US 2022/0018486 A1
(43) Pub. Date: Jan. 20, 2022

(54) EFFECTIVE HEAT SHIELDING AND HEAT DISPERSING APPARATUS

(71) Applicant: Peter Renteln, Scottsdale, AZ (US)

(72) Inventor: Peter Renteln, Scottsdale, AZ (US)

(21) Appl. No.: 16/929,625

(22) Filed: Jul. 15, 2020

(51) Int. Cl. F16L 59/02; F16L 59/08; F28F 13/00

(52) U.S. Cl. CPC F16L 59/029; F16L 59/08; F28F 2270/00; F28F 2255/00; F28F 13/00

(57) ABSTRACT

A heat shielding apparatus capable of dynamically responding to incident heat flux of changing ratio of thermal radiation and convective heat, wherein the dynamic response comprises thermal conduction of the incident heat to a region of lower ambient temperature, and substantive reflection of the incident thermal radiation.

### TECHNICAL FIELD

The present invention relates generally to the use of a heat shield as a means to block, dissipate and insulate from heat, where heat dissipation occurs via the three main mechanisms of heat transfer: Conduction, convection and emission of thermal radiation. Such a device could be used, for example, in personal protective equipment (PPE) to protect the wearer from high heat or direct flame, or as heat shield material to protect cooler, heat-sensitive areas from hotter areas, such as is used in a number of applications including aerospace, battery technology, solar power systems and automotive. Because of their properties of high melting temperature and high thermal conductivity, some carbon-based materials are well suited for use in such heat shields.

### BACKGROUND

Thermal Protection Materials (TPMs) are used to separate spatially proximate regions having different desired temperature ranges. In different applications thermal barriers comprising of one or more TPMs may have different constructions and can be made of different kinds of materials to improve effectiveness. In Aerospace, for example, a thermal barrier might be made of sheets of metal separated by an air gap or an insulator, while a thermal barrier for the nose cone of an orbital reentry vehicle might be made of just ceramic tile, such as was used on the Space Shuttle. Personal Protective Equipment (PPE) for firefighters comprises three different kinds of TPM: A very tough, heat-resistant material such as the polymer Polybenzimidazole (PBI), used as the outer shell, a moisture barrier layer and an insulating layer. As insulators, most TPM materials act to significantly decrease conduction and convection. For example, a household potholder mitt protects the wearer from both hot solid materials which transfer heat (burn) through conduction, as well as from hot air or steam which can transfer heat through convection. For each application, the primary mechanism employed by the thermally protective material is to thermally isolate temperature-sensitive areas from hot areas.

However, some specialized PPE is designed to reflect thermal radiation rather than insulate, such as the metallic-coated reflective apparel used in the metal production and smelting industries. Such PPE is used because the heat from hot liquid metal is mostly in the form of thermal radiation. Therefore, reflecting this radiation creates an effective thermal barrier. However, the hot liquid metal also heats the ambient air, so an additional insulation layer is added to the apparel to minimize heat transfer resulting from convection. In this case, the total desired effect of the thermal barrier is best achieved by the use of two different types of TPM.

To facilitate the ensuing discussion, it is instructive to separately consider the quantitative attributes of each heat transfer mechanism:

### 1. Conduction

Heat transfer through conduction occurs within a single material, or among adjacent materials (typically solids) in direct contact with each other. Within a single material, the amount of heat conducted depends on the thermal conductivity of the material (k), the cross-sectional area that the heat is passing through (A), the distance (L) over which the temperature difference (ΔT) occurs, and ΔT itself. The dependence is given by the expression, where Q represents the quantity of thermal energy transferred per unit time:

Q=−k(A/L)(ΔT),

The dependence of conductive heat transfer on the cross-sectional area of the material means that if the material is thicker, it will be able to conduct more heat.

### 1. Convection

Heat transfer through convection occurs when materials at a higher temperature have a boundary (e.g., surface) in contact with a fluid such as air at a lower temperature. The formula governing the amount of heat exchange is given by:

Q=h_{c}AΔT,

where h_{c} is the Convective Heat Transfer Coefficient, a parameter dependent primarily on air speed, A is the surface area of the material in contact with air, and ΔT is the difference in temperature between the material and the air. Heat transfer by way of convection is therefore enhanced when the material is at higher temperature and the hot area is larger. Because of the ΔT term, convection will be reduced or even reversed when the air temperature is high.

### 3. Thermal Radiation

Thermal radiation is the electromagnetic radiation emitted by a body at a non-absolute zero temperature. For a cubic-shaped body, and integrating over all wavelengths, thermal radiation is a strong function of temperature. The governing equation describing the dependence of the radiant emittance on temperature¹ is given by the Stephan-Boltzmann Law:

J*=σT⁴.

¹ J. S. Tenn, Sonoma State University, Planck's Derivation of the Energy Density of Blackbody Radiation
The strong fourth power dependence on absolute temperature means that the higher the temperature of the radiating material, the more it will emit energy in the form of radiant heat—with a superlinear dependence. For example, a doubling of the absolute temperature will result in a 16-fold increase in the intensity of the thermal radiation emitted. Furthermore, since J* is derived for a solid cubic-shaped body, Jₜ for a body of length P, width P and thickness t is given by

Jₜ=t/P×J*.

In this context, the term “blackbody radiation” refers to electromagnetic radiation emitted by an idealized opaque, non-reflective body; the term “thermal radiation” refers to that sub-set of the electromagnetic spectrum with wavelengths from about 700 nm to about 10,000 nm which can be felt by the human body.

### SUMMARY

The inventions described herein generally relate to heat shields in the form of a substantially planar heat conducting panel, with a longitudinal direction along a longest axis of the panel (FIG. 1A); a lateral direction perpendicular to the longitudinal direction in the plane of the panel (FIG. 1B), and a thickness direction (FIG. 1C) perpendicular to the plane made by the length and the width, where the length and width are substantively greater than the thickness. The panel may exhibit anisotropic behavior within the plane of the panel, but greater anisotropy within any plane perpendicular to the plane of the panel. For example, a heat panel exhibits anisotropic behavior such that the thermal conductivity is greatest in the longitudinal direction, lower in the width (lateral) direction, and least in the direction normal to the plane of the panel.

Various embodiments of the invention involve a generally planar segment of heat shield (insulating and/or radiating) material of arbitrary shape, exhibiting anisotropic behavior within the plane of the material, and which is thin relative to a characteristic dimension of the material segment (e.g., length, width). Regardless of shape, the heat shield comprises one or more layers, and comprises a front face and a rear face, in which the rear face is maintained at a lower temperature than the front face when the front face is exposed to heat. In a preferred embodiment, the shield comprises a plurality of layers, in which one or more of the layers comprises a high-temperature carbon-based material (CBM) with good thermal conductivity in at least in the longitudinal direction, and where each layer of CBM is optionally separated from another layer of CBM by at least a thermally insulating layer.

To facilitate effective heat shielding and heat dissipating properties of the thermal barriers described herein, each component (e.g., layer) of the heat panel advantageously maintains its structural integrity (or at least resists significant structural degradation) at high temperature. For example, each layer should not significantly melt, disassemble, decouple, degrade, oxidize or outgas when exposed to temperatures below the maximum operating temperature. Certain carbon-based materials, i.e. materials that consist of mostly carbon, such as those greater than 90% carbon by weight, have a high melting temperature and are strongly resistant to oxidation and corrosion. As such, they are particularly useful as heat shields. Both Carbon Nanotubes (CNT) and Graphene have highly desirable properties, but presently known fabrication processes do not permit neither a single CNT (a 1-D molecule) nor a single Graphene sheet (a 2-D molecule) to be effectively aggregated into a bulk (3-D) material without at least some compromise of the extraordinary physical, thermal and/or electrical properties of the underlying 1-D and/or 2-D constituent components. Although CNTs have been accumulated into CNT yarn and ribbon modalities exhibiting excellent thermal conductivity, they tend to be extremely expensive and thus prohibitive for use as bulk thermal barriers.

In a preferred embodiment, a suitable carbon based heat shield material with a very high melting temperature comprises carbon fiber tow. Tow consists of the carbon backbone of a polymeric material, such as polyacrylonitrile (PAN) that has been stripped of its hydrogen and other moieties by subjecting it to high temperature. The residual carbon backbone can be made to form a fiber, typically 5 to 10 micrometers in diameter and grouped together in bunches, yielding a very low cost alternative to materials made from carbon nanotubes and graphene. The melting temperature of carbon fiber tow is about 1200° C., which is a useful attribute for a heat panel material. Carbon fiber tow is commercially available in the form of bundles of the fibers, and is generally designated by the number of fibers. For example, a “6 k Carbon Fiber Tow” would have about 6000 fibers.

Because carbon fiber tow consists of a loose bundle of fibers which are not bound together, its integrity can be enhanced using a number of different methods according to the invention. In one embodiment, the tow is coated with a high-temperature adhesive (FIG. 1D). The tow plus adhesive can be manipulated to form a “ribbon” shape, that is, possessing a thin dimension having a thickness of less than about 200 micrometers, and a width of about 2 mm to about 5 cm. While a more cylindrical shape could be formed, a ribbon shape can be advantageous in the fabrication of a heat shield, since ribbons can be effectively aggregated into a planar barrier material and applied over a two-dimensional boundary surface.

Various embodiments also contemplate a very high temperature adhesive made from, for example, sodium silicate, sometimes known as “water glass”, having a usable temperature up to about 1100° C. (Available from PQ Corporation, Malvern, Pa.). Such an adhesive can substantially improve the integrity of the tow both by holding the fibers together, and by protecting the fibers from the environment. Since sodium silicate adhesive dries to a “glassy state”, coating the carbon fiber tow with such an adhesive will generally create a glassy barrier, encasing the fibers and mitigating their separation during use. And since the adhesive can operate normally up to very high temperature, the presence of the adhesive will not reduce the overall operating temperature range of the heat panel.

Although being encased in a “glassy” material has the advantage of containing and protecting the fibers of the tow, it can have an undesirable characteristic of being brittle. In order to mitigate this effect, other, similar high temperature adhesives such as silicates with different silica-to-alkali ratios, as well as different kinds of silicate such as potassium silicate or lithium silicate can be employed in addition to or in lieu of the aforementioned sodium silicate. Alternatively, with or without the use of an adhesive, the tow could be bound and held in place by an ultra-high temperature thread, twine or narrow rope, wrapped repeatedly around the tow. In one embodiment, the thread could be of the type made of Inconel strands with an operating temperature of about 2000 deg. F. Alternatively, the thread may be formed from additional carbon fiber tow, carbon nanotube rope or ribbon, or combinations or composites thereof. In additional embodiments, a ceramic thread could be used.

Since fibers formed into ribbons of even high thermal conductivity material exhibit a limited heat carrying capacity if they are too thin, a configuration comprising a plurality of stacked ribbons (FIG. 1E) could serve the purpose of significantly improving longitudinal conduction and reducing peak temperature due to a spot source. And while this objective could be advanced by using a single, thicker CBM, the use of a plurality of layers can be advantageous. For example, due to the greater thermal conductivity of the CBM in any planar direction compared to the normal direction, each layer of the stack will contribute to channeling the heat away from the hottest spot within the plane, while heat transfer from the hottest layer to other layers is hindered by the lower thermal conductivity in the normal direction. In additional embodiments, insulation between layers could be used, further retarding the transfer of heat to lower layers of the stack occurs. Therefore, peak heat at a spot on the front face is minimized at the rear face.

In the case of a stacked arrangement of carbon fiber tow formed into ribbons, the protective glassy adhesive could be applied to the top tow layer separately from the rest of the layers, and allowed to dry or partially dry before placing it on top of the other carbon tow layers. This would have the effect of making the adhesive layer thinner. A thinner layer will have greater flexibility. Then the stack could be affixed by the Inconel thread, the additional carbon fiber tow, or any suitable high temperature thread-like material. Such an arrangement would help to mitigate brittleness in the sodium silicate glue, particularly for thin glue layers.

Another advantage of a stacked structure when the uppermost layer cannot readily transfer heat to the layer below it is that it will reach a higher temperature than it would if it were thicker or heat were allowed to transfer to the layer below. Additionally, it will also reach this higher temperature sooner than it would if vertical thermal conductivity were higher. A higher temperature assists in all three mechanisms of heat transfer. Convection will be greater due to a higher ΔT term, and thermal radiation will be greater due to a higher T⁴ term. Thermal conduction will also be greater due to the same higher ΔT term, resulting in more of the heat panel getting hotter, and thus a larger area for convection to take place. When the highest temperature point on the heat panel is made higher, the area of the heat panel at elevated temperature increases, thus increasing the area over which convection and thermal radiation mechanisms operate.

Since each CBM layer below the uppermost layer is substantially isolated from air, the lower layers are mostly unable to dissipate significant quantities of heat through convection. But the lower layers can still serve the purpose of spreading out the heat, thereby assisting the outermost layer with reduction of peak heat. Further, when the outer layer in contact with air transfers heat to the air and cools, if the layers below are then hotter than the outer layer, they can transfer heat to the outer layer, enabling further convection to occur. Together, then, the plurality of layers of CBM and the optional high temperature glue significantly reduce both the peak temperature and the heat flux at the base of the panel.

In the example of using the heat panel for PPE, reduction of both peak temperature and heat flux both serves to protect a wearer of the garment, and protects garments worn beneath the heat panel from exceeding their breakdown temperature, thus maintaining their integrity and functionality. Additionally, thin layers are more flexible than thick layers, making such a stacked construction more suitable for PPE.

When local air temperature, such as the air adjacent a high intensity heat source becomes high, heat transfer due to convection at that spot becomes low because ΔT is low. Dissipating this heat by way of convection requires that the air temperature be cooler than the heat panel. By virtue of the relatively poor thermal conductivity of the heat panel in the normal direction (orthogonal to the plane of the material), the uppermost heat panel will become very hot, enabling greater conduction in the longitudinal direction (parallel to the plane of the material) away from the heat source. As the air temperature farther away from the heat source is lower, convection resulting in heat dissipation is again enabled.

The time response of the conduction mechanism of heat transfer will be a function of the thermal conduction in the plane of the panel. Good conduction requires both high thermal conductivity, and a large cross-sectional area. The greater the product of thermal conductivity and cross-sectional area, the faster the heat dissipation response will be, and the faster the heat panel can respond to a sudden temperature rise. It is evident, then, that a heat panel with more heat conducting layers will dissipate heat better than a heat panel with fewer conducting layers.

Heat sources such as flame from a forest fire or a rocket engine typically transfer heat through both convection, by heating the air in the vicinity of the heat source, and through thermal radiation from the heat source directly. Further, a forest fire is very dynamic, constantly changing the ratio of incident energy due to convection and that due to thermal radiation². Various heat shield compositions contemplated by this disclosure may be configured to not only shield against both types of incident heat, but to also be effective as a heat shield in an environment of rapidly shifting heat sources. ² Radiant flux density, energy density and fuel consumption in mixed-oak forest surface fires, R. L. Kremens, et al., International Journal of Wildland Fire 2012, 21, 722-730

The use of a reflective (e.g., metallic) layer (FIG. 1F) to reflect incident thermal radiation may be particularly useful in reflective suits worn as PPE, for example when operating near a source of extremely hot liquid metal. Liquid steel, for example, is generally hotter than a forest fire, but PPE for working around it comprises only a reflective suit and a thin layer of insulation. This is because the thermal radiation generated by the liquid steel is very intense due to its temperature and volume. But its ability to heat the surrounding air is relatively limited due to the small surface area of the liquid in contact with air, and can be further reduced by generating air flow. The addition of a reflective layer on a firefighter's gear would thus substantially decrease the average heat load to which the firefighter is exposed.

The addition of a metallic reflective layer (e.g., comprising copper) on the heat panel of a thickness greater than about 0.1 micrometers may reflect about 95% of incident thermal radiation. By affixing a copper layer greater than 0.1 micrometers in thickness to the rear face of the heat panel, almost all incident thermal radiation can be reflected away, further protecting the rear area of the panel. This is also true for thermal radiation emitted from the CBM. In a dynamic fire situation such as a forest fire, therefore, the heat panel reflects nearly all of the thermal radiation, regardless of the percent of incident heat that comes from thermal radiation.

Such a heat panel, then, may be characterized as dynamically employing four mechanisms of thermal protection; that is the reflection (heat redirection) mechanism operates in conjunction with the conduction, convection and radiation heat dissipation mechanisms. These four mechanisms work in response to the nature of the incoming heat. While incoming heat radiation is almost fully reflected by the reflector layer, incoming convective heat is dissipated by the CBM by conduction to cooler areas followed by convection with the cooler air. Further, when the temperature at a spot becomes high enough, thermal radiation emitted from the CBM becomes significant. This emission will assist thermal conduction in lowering peak heat. All of these mechanisms working together result in a very high heat shielding effectiveness.

Another aspect of the heat shielding effectiveness of the heat panels discussed herein involves improved characteristic response times. The characteristic response time for each mechanism must be low in order for the response time of the heat panel as a whole to be low. The use of a metallic reflective layer greatly assists in this effort, since reflection of thermal radiation is instantaneous and essentially independent of intensity. The thickness of the CBM is another factor affecting the response time of the heat panel. A thicker CBM will result in a faster response time. Additionally, low thermal conductivity in the direction normal to the face of the panel will also help improve the response time of the panel by forcing the outermost layer of the CBM to get hotter for a given incident heat.

In summary, a heat shield construction comprising an anisotropic planar layer over a metallic reflective layer can offer a dynamic, rapid and effective heat protection against a heat source consisting of a shifting ratio of convective and radiative heat.

In additional embodiments, the heat panel could be affixed to an insulating layer (FIG. 1G). An insulating layer placed below the metallic reflective layer can further protect the region below it from the heat which reaches the rear of the heat panel. For example, the PBI material has an operating temperature up to about 635 deg. C. so the temperature should be kept below that to avoid degradation of the material. An insulation layer can greatly assist in this effort. For example, a layer of silica glass, acrylic-coated fiberglass, or fire retardant carbon fiber sheet could be used as an insulating material. Such a layer could be placed above or below a metal reflection layer.

In additional embodiments, the heat panel is usable as a stand-alone heat shield, simply by being positioned between a heat source and a region desired to be kept cooler. Alternatively, the heat panel could be mounted or affixed to a rigid surface, a semi-rigid surface or a flexible surface, to protect the surface material or to maintain the temperature of the surface to below the temperature that would be reached if the heat sources were allowed to become incident on the surface directly.

In additional embodiments, the heat panel can be configured for utility as a thermally protective blanket, such as those used to protect people, animals and things from imminent fire danger. In additional embodiments, the heat panel can be configured for utility as a thermally protective shelter, such as those used by firefighters in the event they cannot escape the proximity of a fire.

### BRIEF DESCRIPTIONS OF THE DRAWINGS

FIG. 1 illustrates one embodiment of the construction of a heat panel.

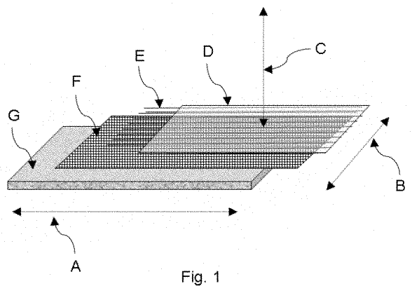

FIG. 2 illustrates the preferred embodiment of the construction of a heat panel.

### DETAILED DESCRIPTION OF PREFERRED EXEMPLARY EMBODIMENTS

The following detailed description is merely exemplary in nature and is not intended to limit the invention or the application and uses of the invention. Furthermore, there is no intention to be bound by any theory presented in the preceding background or the following detailed description.

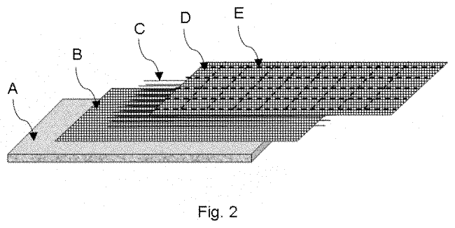

A 0.020 inch diameter wire square copper mesh (FIG. 2B) with 220×220 wires per inch is cut into a 6-inch by 8-inch panel. Ten, 8-inch long bundles of 50 k carbon fiber tow are stacked lengthwise on the copper mesh such that the strands are parallel and spread out to a width of 1 inch. Another stack of ten, 8-inch long bundles is similarly positioned adjacent and in contact with the first bundle, is also spread out to cover a width of 1 inch. Repeating this construction for the remaining 4 inches of width such that each stack of bundles has been laid parallel and adjacent one another, the entire area of 6 inches by 8 inches is covered by ten layers of carbon fiber tow oriented with the highest thermal conductivity in the length direction (FIG. 2C). The tow is then covered by a layer of 0.0047″ diameter wire square copper mesh with 70×70 wires per inch (FIG. 2D). In alternative embodiments, the carbon fiber tow be positioned such that one or more layers are parallel and in the lengthwise direction, and other layers are parallel but in a different direction such as the width direction.

A layer of 6″×8″ fire retardant carbon fiber sheet (FIG. 2A) is placed underneath the 220×220 copper mesh layer, and both the entire stack including the upper copper mesh layer, the carbon fiber tow layer, the lower copper mesh layer and the insulation layer are then sewn together an using ultra-high temperature (e.g. ceramic or Inconel core) thread (FIG. 2E). The stitching pattern comprises stitches parallel to the length of the panel, spaced apart by about 1 inch, but could be spaced closer together or farther apart. A second row of stitches, perpendicular to the length of the panel, is made across the entire width of the panel, also sewing all layers together, and also about an inch apart. The stitching in a square-cross pattern allows easier bending of the panel along its length and width directions. And the close spacing of the stitches allows the panel to be cut into arbitrary shapes while still keeping the carbon tow securely in place. An externally visible arrow or other indicia is made available to indicate the direction of greatest thermal conductivity.

In an additional preferred embodiment, the insulation layer is the bottom layer for the construction of a panel. Multiple strips of 50 k carbon fiber tow with a thickness determined by the number of layers used, are created. A final, uppermost layer of 50 k carbon fiber tow is immersed in sodium silicate glue, and dried in an oven. All layers of the carbon fiber tow are affixed to a wire mesh using 1 k carbon tow as thread. The carbon tow, the copper mesh and the insulation layer are sewn together using ultra-high temperature thread. Together, the layers comprise a heat shield in the form of a panel. The panel can then be used by simple placement between a heat source and a heat sensitive area, or can be attached by any combination of glue, Velcro, tape, hooks, screws, nails, or the like.

### Example 1

A swath of PBI fabric, (PBI Performance Products, Charlotte, N.C.), often used as turnout gear for firefighters, was subjected to a heat stress test. A butane torch was placed 5.25 inches from the front surface of the fabric, which in prior tests resulted in a front side temperature of 800 degrees C. in under two minutes. An IR sensor was pointed at the rear face of the PBI fabric such that the measured spot was directly behind the target spot of the flame on the front side of the fabric. A timer was started simultaneously to the onset of flame, and temperature indicated by the thermocouple was recorded at regular intervals of 15 seconds for a duration of two minutes. The recorded temperature rose rapidly to a value of about 538 deg. C., before a hole was formed at the front spot where the flame was pointed. The hole formed in under 40 seconds and the test was stopped. The PBI fabric was observed to have blackened around the edges of the missing (burned) material.

A heat panel made similarly to the description held forth in the “Detailed Description of Preferred Exemplary Embodiments” was sewn onto a swath of PBI fabric and subjected to the same heat stress test as was conducted on the PBI fabric by itself, where the butane torch was aimed at the front face of the heat panel. For this test, a thermocouple was employed on the rear face of the PBI fabric to measure temperature. The tip of the thermocouple was positioned in physical contact with the PBI fabric at a spot just behind where the incident heat from the butane torch was applied. The temperature was again measured at regular, 15 second intervals and recorded. From a starting temperature of 25 deg. C., temperature of the rear face of the PBI rose in approximately linear fashion to a final temperature of 140 deg. C. after two minutes of continuous exposure to the flame. The PBI fabric remained intact, although a light, faint brown tint could be seen on the rear face.

From these experimental data, it was concluded that the effect of the heat panel was to lower the temperature of the PBI fabric by over 600 deg. C. after two minutes of constant exposure to the heat source.

1. A heat shielding apparatus, comprising:
a substantially planar layer of material;
wherein the material comprises a carbon-based component; and
the carbon-based component exhibits at least one thermally anisotropic property.

2. The heat shielding apparatus of claim 1, wherein:
the apparatus comprises a heat conducting panel;
the panel is characterized by a length L, a width W, and a thickness T; and
L>T, and W>T.

3. The heat shielding apparatus of claim 1, wherein the thermally anisotropic property comprises anisotropic thermal conductivity.

4. The heat shielding apparatus of claim 1, wherein the material exhibits greater thermal conductivity in a first direction within the substantially planar layer of material than in a second direction normal to the planar layer of material.

5. The heat shielding apparatus of claim 1 wherein the carbon-based material comprises Carbon Fiber Tow.

6. The heat shielding apparatus of claim 1, further comprising a plurality of layers of carbon-based material in which each layer is in direct contact with an adjacent layer.

7. The heat shielding apparatus of claim 1, further comprising a plurality of layers of carbon-based material in which at least one layer is separated from an adjacent layer by an insulating layer, wherein the insulating comprises a material having a lower thermal conductivity, than the adjacent carbon-based layer in a direction corresponding to the length L.

8. The heat shielding apparatus of claim 1, further comprising a reflective metallic layer.

9. The heat shielding apparatus of claim 1 comprising a thermally insulating layer.

10. The heat shielding apparatus of claim 5, wherein:
the Carbon Fiber Tow comprises a bundle of fibers; and
the bundle of fibers are bound together by an adhesive comprising a sodium silicate glue.

11. The heat shielding apparatus of claim 5, wherein:
the Carbon Fiber Tow comprises a bundle of fibers; and
the bundle of fibers are bound together by a high-temperature thread.

12. The heat shielding apparatus of claim 5, wherein:
the Carbon Fiber Tow comprises a bundle of fibers; and
the bundle of fibers are bound together by a high temperature thread made from carbon nanotubes.

13. The heat shielding apparatus of claim 5, wherein:
an externally visible arrow or other indicia is made available to indicate the major direction of the at least one thermally anisotropic property.

14. A protective garment comprising the heat shielding apparatus of claim 1.

15. A protective thermal blanket comprising the heat shielding apparatus of claim 1.

14. A protective thermal shelter comprising the heat shielding apparatus of claim 1.

15. A heat shielding apparatus capable of dynamically responding to incident heat flux of changing ratio of thermal radiation and convective heat, wherein the dynamic response comprises thermal conduction of the incident heat to a region of lower ambient temperature, and substantive reflection of the incident thermal radiation.
